(19) United States
(12) Patent Application Publication
(10) Pub. No.: US 2008/0123370 A1
(43) Pub. Date: May 29, 2008

(54) Backlight module with individual frame beams and liquild crystal display with same

(75) Inventors: Sin-Tung Huang, Miao-Li (TW); Lin-Dong Fang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/998,053

(22) Filed: Nov. 27, 2007

(30) Foreign Application Priority Data
Nov. 27, 2006 (TW) 95220884

(51) Int. Cl. F21V 7/04

(52) U.S. Cl. 362/633

(57) ABSTRACT

An exemplary backlight module includes a tray and at least two opposite frame beams. The tray includes two opposite side walls, and the side walls include a plurality of first fixing members. The two frame beams are separate pieces from each other, and include a plurality of second fixing members secured with the first fixing members such that the two frame beams are fixed to the tray. A liquid crystal display including the backlight module is also provided.

### FIELD OF THE INVENTION

The present invention relates to a backlight module that includes a plurality of individual frame beams, and a liquid crystal display (LCD) including the backlight module.

### BACKGROUND

Liquid crystal displays are commonly used as display devices for compact electronic apparatuses, not only because they provide good quality images but also because they are very thin. Liquid crystal in a liquid crystal display does not emit any light itself. The liquid crystal requires a light source so as to be able to clearly and sharply display text and images. Therefore, a typical liquid crystal display requires an accompanying backlight module.

Referring to FIG. 8, a typical backlight module 10 includes a top plastic frame 12, a light guide plate 14, a light source 16, and a metal bottom tray 18. The top frame 12 includes four side walls 122 integrally arranged end to end, and a peripheral spacing board 124 inwardly extending from inner surfaces (not labeled) of the side walls 122. A plurality of protrusions 126 outwardly extend from outer surfaces (not labeled) of the side walls 122. The bottom tray 18 includes a bottom plate 184, and four side plates 182 upwardly extending from edges of the bottom plate 184. A plurality of notches 186 are defined in the side plates 182, respectively corresponding to the protrusions 126 of the top frame 12. The light source 16 is located adjacent to a long side edge of the light guide plate 14.

When the backlight module 10 is assembled, the light guide plate 14 and the light source 16 are accommodated in the bottom tray 18. Then the protrusions 126 of the top frame 12 are respectively received in the notches 186 of the bottom tray 18. Thereby, the top frame 12 and the bottom tray 18 are secured with each other.

The top frame 12 is generally made by an injection molding method. This typically requires a large-sized mold, because of the broad expanse of the structure of the top frame 12. The need for a large-sized mold adds to the cost of manufacturing the top frame 12. Furthermore, when a preform of the top frame 12 is made, steps of examining a distance between two opposite long side walls 122 and examining a distance between two opposite short side walls 122 are required. These steps are needed to ensure that the top frame 12 can be fittingly engaged to the bottom tray 18. Such steps further contribute to the cost of manufacturing the top frame 12.

What is needed, therefore, is a backlight module that can circumvent, overcome or at least mitigate the above-described difficulties. What is also need is a liquid crystal display including the backlight module.

### SUMMARY

In an exemplary embodiment, a backlight module includes a tray and at least two opposite frame beams. The tray includes two opposite side walls, and the side walls include a plurality of first fixing members. The two frame beams are separate pieces from each other, and include a plurality of second fixing members secured with the first fixing members such that the two frame beams are fixed to the tray. A liquid crystal display including the backlight module is also provided.

Other aspects, novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is an exploded, isometric view of a backlight module according to an exemplary embodiment of the present invention.

FIG. 2 is an enlarged view of a circled portion II of FIG. 1.

FIG. 3 is an enlarged view of a circled portion III of FIG. 1.

FIG. 4 is an enlarged view of a circled portion IV of FIG. 1.

FIG. 5 is an enlarged view of a circled portion V of FIG. 1.

FIG. 6 is a fully assembled view of the backlight module of FIG. 1.

FIG. 7 is an exploded, side-on view of an exemplary liquid crystal display of the present invention, the liquid crystal display including the backlight module of FIG. 1.

FIG. 8 is an exploded, isometric view of a conventional backlight module.

### DETAILED DESCRIPTION OF PREFERRED EMBODIMENTS

Reference will now be made to the drawings to describe preferred and exemplary embodiments of the present invention in detail.

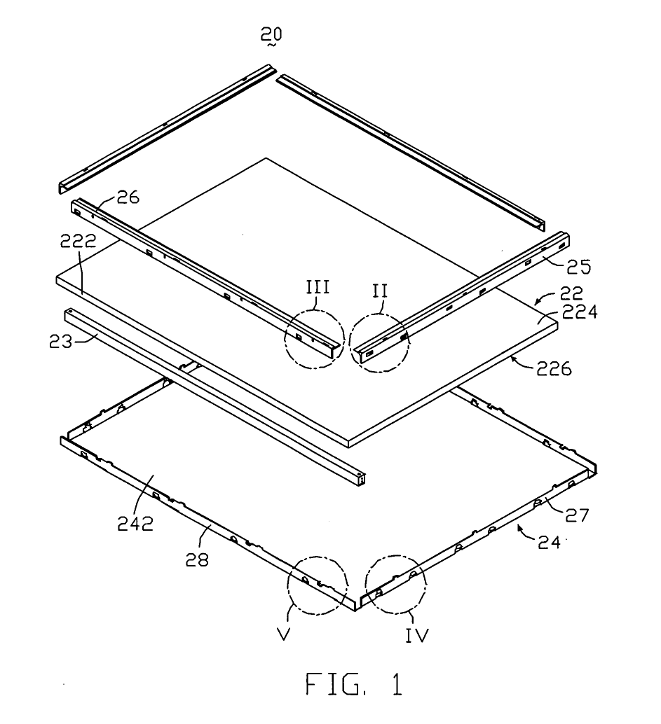

Referring to FIG. 1, a backlight module 20 according to an exemplary embodiment of the present invention is shown. The backlight module 20 includes a light guide plate 22, a light source 23, a pair of individual first frame beams 25, a pair of individual second frame beams 26, and a bottom tray 24.

The light guide plate 22 is substantially rectangular. The light guide plate 22 includes a top light emitting surface 224, a bottom surface 226, and a light incident surface 222 between the light emitting surface 224 and the bottom surface 226. The light guide plate 22 can for example be made from polycarbonate (PC) or polymethyl methacrylate (PMMA), and can be manufactured by an injection molding method.

The light source 23 is located adjacent to the light incident surface 222 of the light guide plate 22, in order to provide light beams for the backlight module 20. The light source 23 includes a linear illuminator (not shown), which can for example be a cold cathode fluorescent lamp (CCFL).

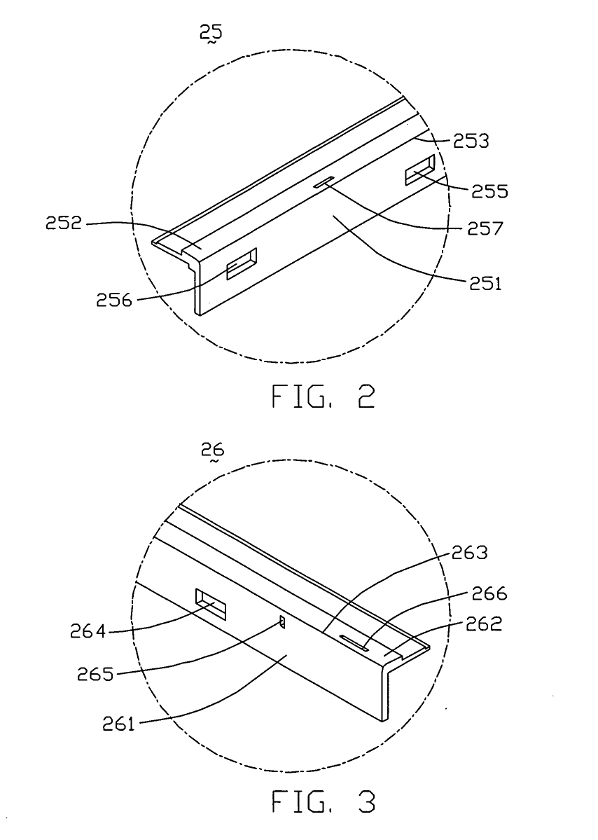

Each first frame beam 25 is substantially linear, and has an essentially L-shaped profile. Referring also to FIG. 2, the first frame beam 25 includes a first plate 251 and a second plate 252 perpendicularly extending from the first plate 251. The first plate 251 includes a plurality of first notches 255 and second notches 256 defined therein. The first and second notches 255, 256 are substantially rectangular. A distance between each first notch 255 and a junction 253 of the first and second plates 251, 252 is greater than a distance between each second notch 256 and the junction 253. The second plate 252 has a greater thickness adjacent to the junction 253, and has a lesser thickness farther away from the junction 253. The second plate 252 includes a plurality of third notches 257 defined therein. The third notches 257 are substantially rectangular, and are adjacent to the junction 253. The first frame beams 25 can for example be made from polycarbonate (PC) or polymethyl methacrylate (PMMA).

Each second frame beam 26 is substantially linear, and has an essentially L-shaped profile. Referring also to FIG. 3, the second frame beam 26 includes a third plate 261 and a fourth plate 262 perpendicularly extending from the third plate 261. The third plate 261 includes a plurality of fourth notches 264 and fifth notches 265 defined therein. The fourth notches 264 and the fifth notches 265 are essentially rectangular. A distance between each fourth notch 264 and a junction 263 of the third and fourth plates 261, 262 is greater than a distance between each fifth notch 265 and the junction 263. The fourth plate 262 has a greater thickness adjacent to the junction 263, and has a lesser thickness farther away from the junction 263. The fourth plate 262 includes a plurality of sixth notches 266 defined therein. The sixth notches 266 are substantially rectangular, and are adjacent to the junction 263. The second frame beams 26 can for example be made from polycarbonate (PC) or polymethyl methacrylate (PMMA).

The bottom tray 24 includes a bottom wall 242, a pair of opposite first side walls 27, and a pair of opposite second side walls 28. The first and second side walls 27, 28 perpendicularly extend from edges of the bottom wall 242. Thereby, the bottom wall 242, the first side walls 27, and the second side walls 28 cooperatively define a space (not labeled) for accommodating the light guide plate 22 and the light source 23. In the illustrated embodiment, the first and second side walls 27, 28 are separate from each other. That is, a gap is defined where adjacent first and second side walls 27, 28 meet each other at each of four corners of the bottom tray 24. The bottom tray 24 can for example be made from steel, iron, aluminum, magnesium, or any suitable alloy that includes at least one of these metals.

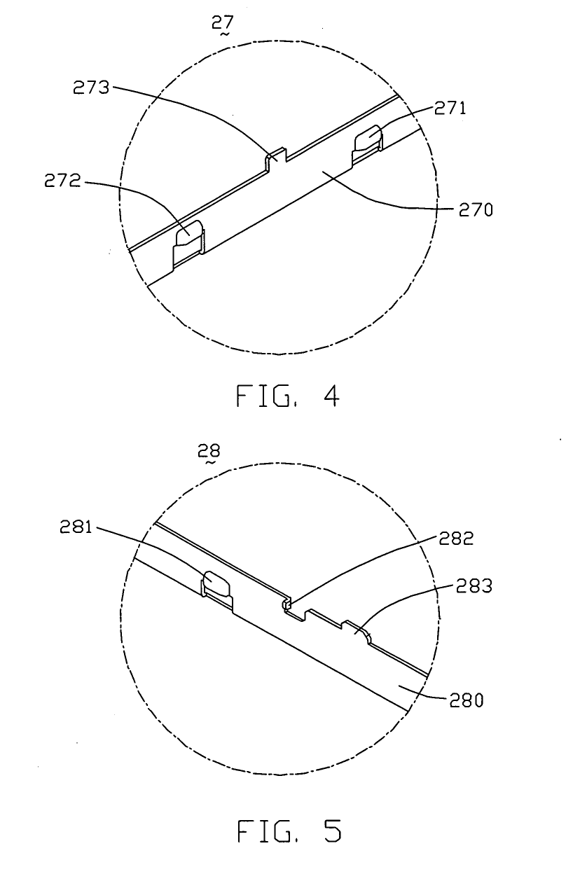

Referring also to FIG. 4, each first side wall 27 includes a plurality of first protrusions 271, second protrusions 272, and third protrusions 273. The first protrusions 271 outwardly extend from an outer surface 270 of the first side wall 27, and correspond to the first notches 255 of the first plate 251 of the respective first frame beam 25. The second protrusions 272 outwardly extend from the outer surface 270 of the first side wall 27, and correspond to the second notches 256 of the first plate 251 of the first frame beam 25. The third protrusions 273 upwardly extend from a top edge (not labeled) of the first side wall 27, and correspond to the third notches 257 of the second plate 252 of the first frame beam 25. The first side wall 27 further includes a plurality of through holes (not labeled) respectively below the first and second protrusions 271, 272.

Referring also to FIG. 5, each second side wall 28 includes a plurality of fourth protrusions 281, fifth protrusions 282, and sixth protrusions 283. The fourth protrusions 281 outwardly extend from an outer surface 280 of the second side wall 28, and correspond to the fourth notches 264 of the third plate 261 of the respective second frame beam 26. The fifth protrusions 265 outwardly extend from the outer surface 280 of the second side wall 28, and correspond to the fifth notches 265 of the third plate 261 of the second frame beam 26. The sixth protrusions 283 upwardly extend from a top edge (not labeled) of the second side wall 28, and corresponding to the sixth notches 266 of the fourth plate 262 of the second frame beam 26.

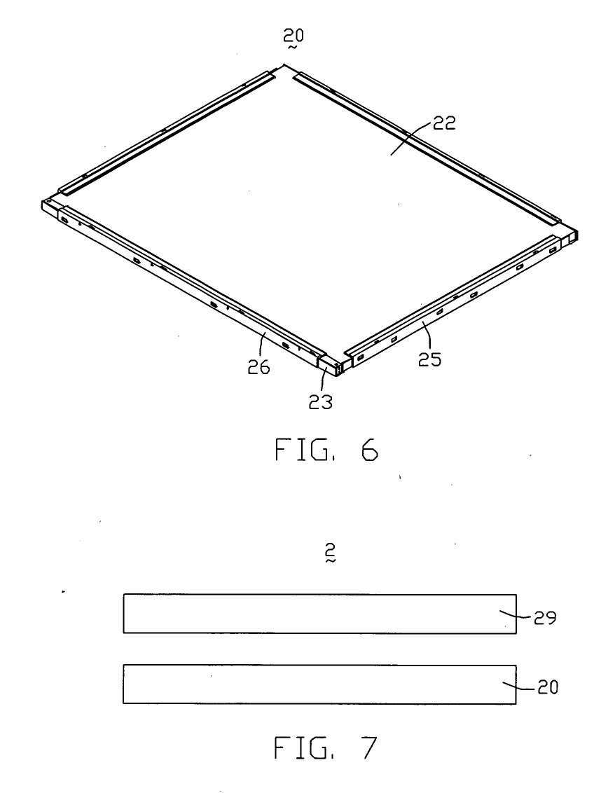

Referring also to FIG. 6, when the backlight module 20 is assembled, the light guide plate 22 and the light source 23 are accommodated in the bottom tray 24. The first frame beams 25 are respectively secured with the first side walls 27 of the bottom tray 24, and the second frame beams 26 are respectively secured with the second side walls 28 of the bottom tray 24. The first plates 251 of the first frame beams 25 fittingly abut the outer surfaces 270 of the first side walls 27. The first protrusions 271 are respectively fixed in the first notches 255 of the first plates 251, thereby defining first engagements. The second protrusions 272 are respectively fixed in the second notches 256 of the first plates 251, thereby defining second engagements. The third protrusions 273 are respectively fixed in the third notches 257 of the second plates 252, thereby defining third engagements. The second plates 252 of the first frame beams 25 fittingly abut edge portions of the light emitting surface 224 of the light guide plate 22. The third plates 261 of the second frame beams 26 fittingly abut the outer surface 280 of the second side walls 28. The fourth protrusions 281 are respectively fixed in the fourth notches 264 of the third plates 261. The fifth protrusions 282 are respectively fixed in the fifth notches 265 of the third plates 261. The sixth protrusions 283 are respectively fixed in the sixth notches 266 of the fourth plates 262. The fourth plates 262 of the second frame beams 26 fittingly abut edge portions of the bottom surface 226 of the light guide plate 22.

Each set of adjacent first, second and third engagements defines an imaginary triangle, with the first, second and third engagements being located at points of the triangle. Each set of first, second and third engagements is mechanically stable, and the sum effect of plural sets of first, second and third engagements is even more stable. Thus, the first frame beams 25 can be reliably secured with the bottom tray 24. For reasons similar to those described above in relation to the first frame beams 25, the second frame beams 26 can also be reliably secured with the bottom tray 24.

The first and second frame beams 25, 26 have individual substantially linear configurations, and can be manufactured by using a small-sized mold. This can help to reduce the cost of manufacturing the backlight module 20. Furthermore, unlike in conventional art, there is no need for examining a distance between the opposite first frame beams 25, and examining a distance between the opposite second frame beams 26. This can further help to reduce the cost of manufacturing the backlight module 20. Therefore, the backlight module 20 has a stable, reliable mechanical structure and low cost.

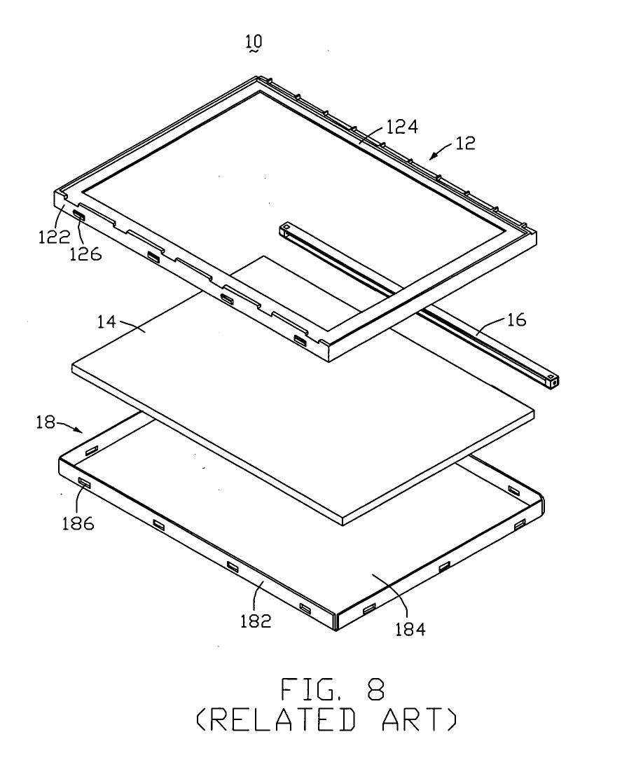

In FIG. 7, a liquid crystal display 2 according to an exemplary embodiment of the present invention is shown. The liquid crystal display 2 includes the backlight module 20, and a liquid crystal panel 29 located adjacent to the light emitting surface 224 of the light guide plate 22 of the backlight module 20. The backlight module 20 is configured to illuminate the liquid crystal panel 29.

Further or alternative embodiments may include the following. In a first example, the first and second frame beams 25, 26 have the same lengths and structures. In such case, the first and second side walls 27, 28 of the bottom tray 24 have corresponding configurations. In a second example, the backlight module 20 includes only a pair of first frame beams 25 or only a pair of second frame beams 26. In a third example, the backlight module 20 includes only a pair of first frame beams 25 and one second frame beam 26, or only a pair of second frame beams 26 and one first frame beam 25.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A backlight module comprising:
a tray comprising two opposite side walls, the side walls comprising a plurality of first fixing members; and
at least two opposite holding beams, the two holding beams being separate pieces from each other, and comprising a plurality of second fixing members secured with the first fixing members such that the two holding beams are fixed to the tray.

2. The backlight module as claimed in claim 1, wherein each of the at least two holding beams is straight.

3. The backlight module as claimed in claim 1, wherein each of the at least two holding beams has an essentially L-shaped profile, and comprises a first plate, and a second plate extending from the first plate.

4. The backlight module as claimed in claim 3, wherein the first plate comprises a plurality of first notches and second notches defined therein.

5. The backlight module as claimed in claim 4, wherein a distance between each first notch and a junction of the first and second plates is greater than a distance between each second notch and the junction.

6. The backlight module as claimed in claim 5, wherein the second plate has a greater thickness adjacent to the junction, and has a lesser thickness farther away from the junction.

7. The backlight module as claimed in claim 5, wherein the second plate comprises a plurality of third notches defined therein.

8. The backlight module as claimed in claim 7, wherein the third notches are adjacent to the junction.

9. The backlight module as claimed in claim 7, wherein the first, second, and third notches are arranged in groups of three, with each group consisting of a first notch, a second notch, and a third notch, and the first, second, and third notches in each group being located at points of an imaginary triangle.

10. The backlight module as claimed in claim 7, wherein each of the at least two sides walls comprises a plurality of first protrusions respectively secured in the first notches, a plurality of second protrusions respectively secured in the second notches, and a plurality of third protrusions respectively secured in the third notches.

11. The backlight module as claimed in claim 10, wherein the first, second, and third protrusions outwardly extend from outer surfaces of the side walls.

12. The backlight module as claimed in claim 10, wherein the side walls further comprise a plurality of through holes respectively below the first and second protrusions.

13. The backlight module as claimed in claim 1, wherein the at least two holding beams are made from polycarbonate or polymethyl methacrylate.

14. The backlight module as claimed in claim 1, wherein the frame is made from one of steel, iron, aluminum, magnesium, and any alloy that comprises at least one of these metals.

15. The backlight module as claimed in claim 1, further comprising at least another holding beam between the two opposite holding beams, wherein the tray further comprises at least another side wall between the two opposite side walls, the at least another side wall comprises a plurality of first fixing members, and the at least another holding beam comprises a plurality of second fixing members secured with the first fixing members of the at least another side wall such that the at least another holding beam is fixed to the tray.

16. A backlight module comprising:
a tray comprising at least two opposite side walls; and
at least two opposite holding beams, the two holding beams being separate pieces from each other, and being secured to the two side walls, thus cooperatively defining a housing assembly of the backlight module.

17. A liquid crystal display comprising:
a liquid crystal panel; and
a backlight module adjacent to the liquid crystal panel, the backlight module comprising:
a tray comprising two opposite side walls, the side walls comprising a plurality of first fixing members; and
at least two opposite holding beams, the two holding beams being separate pieces from each other, and comprising a plurality of second fixing members secured with the first fixing members such that the two holding beams are fixed to the tray.
